(19) United States
(12) Patent Application Publication
(10) Pub. No.: US 2007/0070365 A1
(43) Pub. Date: Mar. 29, 2007

(54) Content-based image retrieval based on color difference and gradient information

(75) Inventors: Lokesh R. Boregowda, Bangalore (IN); Sridevi Ganapathy, Coimbatore (IN); Mohamed M. Ibrahim, Kayalpatnam (IN); Mayur D. Jain, Akola (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/234,989

(22) Filed: Sep. 26, 2005

(51) Int. Cl. H04N 1/60

(52) U.S. Cl. 358/1.9; 358/518

(57) ABSTRACT

An image processing system and method uses color information and texture information to compare a first image and a second image. The color information and texture information are derived independently, and then combined to obtain robust comparison and image retrieval results. For the color features of the images, color component differences are calculated and compared. For the texture features of the images, a multi-dimensional K-means clustering of a gradient vectors are calculated and compared.

### TECHNICAL FIELD

The invention relates to the field of image processing, and in particular, but not by way of limitation, to the processing of image data based on color difference and gradient information.

### BACKGROUND

In today's computer-based society, digital image content has become a vital enterprise asset, and image content management has emerged as a strategic necessity. Consequently, a plethora of video data is created, published, transmitted, and accessed everyday by corporate entities and individuals alike. Image retrieval from large databases is a matter of particular interest for entities handling huge image and video databases. Existing methods for image retrieval use either low level features such as color, texture, shape, and position, or they use high-level semantics such as transform methods and relevance feedback information.

Low level systems that use the features of color and related information for example measure the similarity of images based on the number of occurrences of each color in corresponding partitions of images. Such systems also normally examine the color based upon the standards specified by the International Commission on Illumination (known by the acronym CIE, for Commission Internationale de l'É'clairage) luminance-chrominance color space. However, although color is a prominent feature of most image data, a system that uses color alone does not produce the best query matching for various databases. Some low level systems that also focus on color use color feature vectors in the HSI (Hue, Saturation, Intensity) color space. However, once again, color features in and of themselves will not generate the best results in all image situations, and such methods have to be tuned for different applications.

Because of these problems with low level systems, the state of the art in image database processing has turned to the use of relevance feedback and other high level feature systems. These systems however are computationally intensive and negatively affect the performance of the system. Research is therefore presently underway on content-based image retrieval (CBIR) systems that can retrieve images in an unconstrained environment. However, general solutions to the key problems relating to regions of interest, segmentation, and retrieval have not been solved and are still being sought.

### BRIEF DESCRIPTION OF THE DRAWINGS

FIG. 1 illustrates an example embodiment of a process using color transformation and gradient feature extraction to compare image data.

FIG. 2 illustrates a pixel layout relating to a gradient feature extraction process that may be used in connection with an embodiment of the invention.

FIGS. 3, 4, and 5 illustrate example output produced by an embodiment of the invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, color information and texture information pertaining to image data are used in a complementary manner to correlate images. In such an embodiment, one image is referred to as the query image and a second image is referred to as the database and/or test image. The embodiment uses a composite image retrieval algorithm based on unique color transformation and gradient-edge information as a texture feature. The components of the composite algorithm are performed independently, and then the results are combined to provide a robust image retrieval algorithm. In an embodiment, the color features are obtained by determining the differences between color components, and the texture feature is estimated by executing a multi-dimensional K-means clustering of gradient vectors. The gradient vector is formed using a calculated gradient angle and magnitude. Embodiments of this process may be referred to as content-based querying. The correlation between an image in a database and a query image is referred to as the similarity.

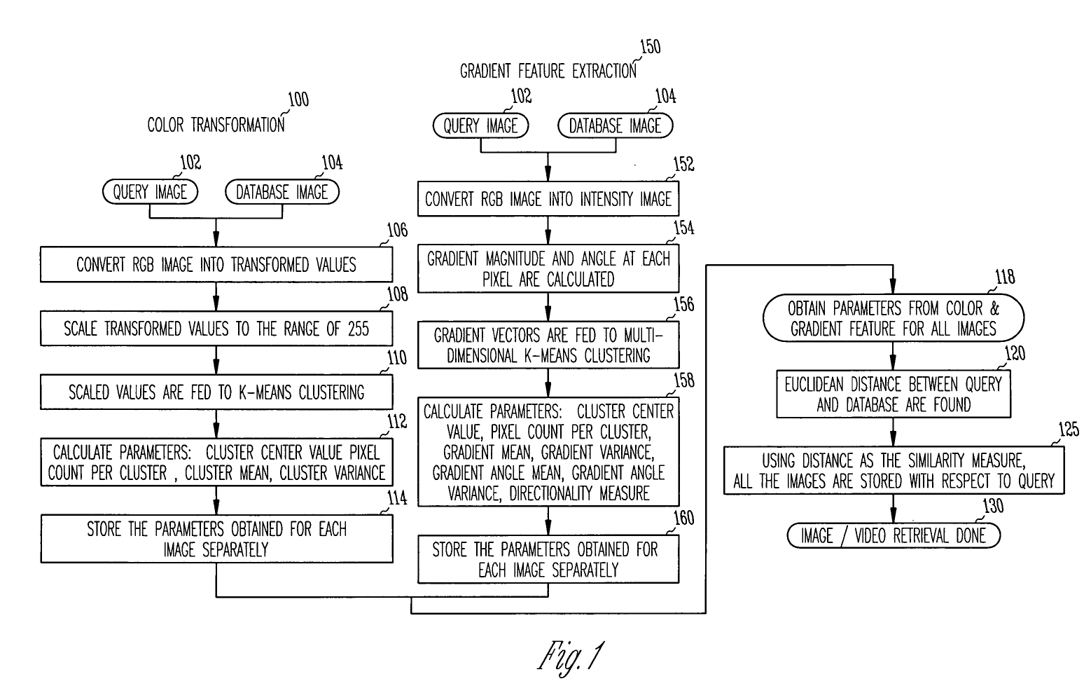

FIG. 1 illustrates an example embodiment of an image processing algorithm that uses a color transformation process 100 and a gradient feature extraction technique 150 to compare and correlate a query image with a database image. In the example embodiment of FIG. 1, a query image 102 is compared with a database image 104. In the color transformation 100, the RGB values obtained from the image 102 are processed at 106 to compute the differences “R−G ”,“G−B” and “B−R” per pixel. In this embodiment, these differences are scaled at 108 to the range (0,255). In other embodiments, other ranges may be used. The transformed RGB values are input into a K-means clustering procedure 110. The parameters 112 obtained from the K-means clustering are the cluster center value, pixel count per cluster, cluster mean, and cluster variance (of the RGB values) for each of the clusters. These cluster parameters are representative of the color variation in the image 102. In this example embodiment, these parameters are stored in the form of a vector at 114 for use as a feature in image matching.

The K-means algorithm 110 minimizes the sum of squared distances between all points in a cluster image and the cluster center. Specifically, the K-means algorithm chooses K initial cluster centers. New cluster centers are then computed such that the sum of the squared distances from all points in an image to the new cluster center is minimized. These steps are then repeated iteratively until the successive iterations result in very near cluster centers for a cluster. In an embodiment of the color transformation process 100, after the K-means algorithm has determined a cluster center, the pixel count per cluster, membership per cluster, and mean and variance per cluster is calculated.

The color transformation process 100 of FIG. 1 is explained further by reference to the following example RGB matrices. Each element of a matrix represents the color intensity value for a pixel for that color represented by the matrix. For example, the R component of the pixel in the second row and second column has an intensity value of 108. The three matrices on the right represent the differences in the pixel values between the paired combinations of the matrices (i.e., R−G, G−B, and B−R).

$$R = [ \begin{matrix}0 & 108 & 108 & 144 & 108 \\ 0 & 108 & 144 & 144 & 144 \\ 0 & 108 & 108 & 144 & 108 \\ 0 & 108 & 144 & 144 & 108 \\ 0 & 36 & 72 & 36 & 36\end{matrix} ] R - G = [ \begin{matrix}0 & 108 & 72 & 72 & 72 \\ 0 & 72 & 108 & 108 & 72 \\ 0 & 72 & 36 & 144 & 72 \\ 0 & 72 & 144 & 108 & 72 \\ 0 & 36 & 72 & 36 & 36\end{matrix} ]$$

$$G = [ \begin{matrix}0 & 0 & 36 & 72 & 36 \\ 0 & 36 & 36 & 36 & 72 \\ 0 & 36 & 72 & 0 & 36 \\ 0 & 36 & 0 & 36 & 36 \\ 0 & 0 & 0 & 0 & 0\end{matrix} ] G - B = [ \begin{matrix}0 & 85 & 0 & 85 & 85 \\ 0 & 85 & 0 & 85 & 85 \\ 0 & 0 & 0 & 85 & 0 \\ 0 & 0 & 0 & 0 & 85 \\ 0 & 0 & 0 & 0 & 0\end{matrix} ]$$

$$B = [ \begin{matrix}0 & 85 & 0 & 85 & 85 \\ 0 & 85 & 0 & 85 & 85 \\ 0 & 0 & 0 & 85 & 0 \\ 0 & 0 & 0 & 0 & 85 \\ 0 & 0 & 0 & 0 & 0\end{matrix} ] B - R = [ \begin{matrix}0 & - 23 & - 108 & - 59 & - 23 \\ 0 & - 23 & - 144 & - 59 & - 59 \\ 0 & - 108 & - 108 & - 59 & - 108 \\ 0 & - 108 & - 144 & - 144 & - 23 \\ 0 & - 36 & - 72 & - 36 & - 36\end{matrix} ]$$

After computation of the R−G, G−B, and B−R matrix differences, the matrices are transformed as follows:
R is replaced by R−G;
G is replaced by G−B;
B is replaced by B−R.

Consequently, whereas the original values for the RGB components of a pixel varied from 0 to 255, after this transformation, the RGB values vary in the range from −255 to 255. In the specialized case where the query image and the database image are the same, the sum of the three transformed RGB matrices will be equal to zero. A similar transformation is applied to the database image 104 to obtain the components:
“R1−G1”, “G1−B1” and “B1−R1”.
   Thereafter, the transformed RGB image component spaces for the query image and the database image are subtracted from one another as outlined below to obtain the color nearness quantification measure “R_Dist”, “G_Dist” and “B_Dist” as follows:
   R_{—}Dist=(R−G)−(R1−G1);
   G_{—}Dist=(G−B)−(G1−B1);
   B_{—}Dist=(B−R)−(B1−R1).
   The nearer to zero that these color distance component values are, the more similar are the query image 102 and the database image 104. If the images are different, then the values of R_Dist, G_Dist and B_Dist, will contain either positive values or negative values, and a larger divergence from zero indicates a greater difference between the query image and the database image. Therefore, in this embodiment, the zero threshold indicates an exact matching. Other embodiments can be designed so that an exact match is indicated by a different threshold.

Referring again to FIG. 1, the gradient feature extraction process 150 works on the same query image 102 and the same database image 104. In the gradient feature extraction process 150, the RGB values of each pixel are read from the image and the intensity image is obtained as the average of the sum of the R, G, and B color components (152). The intensity information alone is sufficient and quashes the need to separately use the three color components R, G and B as in the color based transformation 100. The gradient magnitude and gradient angle are calculated for each pixel that makes up the image at 154 (the image gradient is computed as the root mean square (rms) magnitude of the row difference image and the column difference image. The row difference image and the column difference images are obtained by subtracting the intensity values between the successive rows and columns of the image respectively) and stored in a vector, and the vector for every pixel is used as input for a multi-dimensional K-means clustering procedure at 156. In the gradient-based calculation, the K-means algorithm determines the pixel count, gradient magnitude mean and variance, gradient angle mean and variance, and the directionality measure (DM). The pixel count, gradient mean, gradient variance, gradient angle mean, gradient angle variance, and directionality measure are calculated in this K-means algorithm at 158, and are stored at 160.

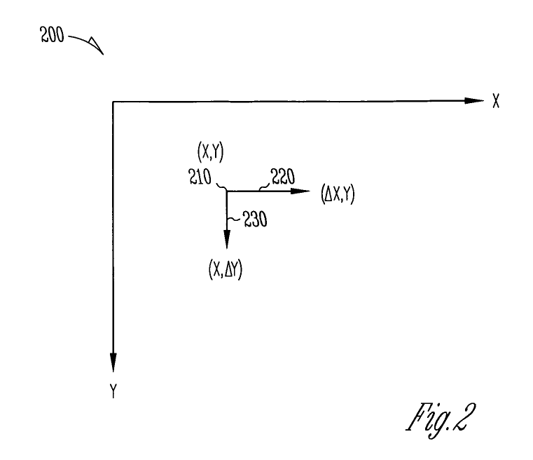

The gradient information for the intensity image (152) is obtained for every pixel, as are the gradient magnitude and the gradient angle. Every pixel is compared with its neighboring pixel for the computation of the magnitude and angle. Specifically, referring to FIG. 2, a pixel schema 200 has a location of (x, y) at point 210. Movement along the x axis produces a neighboring pixel location of (Δx, y) at 220, and movement along the y axis produces a neighboring pixel location of (x, Δy) at 230. In mathematical form, these pixel locations are represented as
Δx=x+1,
and for the immediate neighboring pixel along the y axis,
Δy=y+1.
The distance to a neighboring pixel in the x direction then is
B=(Δx, y)−(x, y),
and the distance to a neighboring pixel in the y direction is
A=(x, Δy)−(x, y).
The gradient magnitude is calculated as follows:
Gradient magnitude=((A²+B²)/2)^{1/2},
and the gradient angle is as follows:
Gradient angle=arctangent (B/A).
The directionality measure is the vector combination of the gradient magnitude and gradient angle.

After computing the parameters for both the color transformation process 100 and the gradient feature process 150, these parameters are accessed at 118 and a Euclidean distance is computed at 120 between like parameters in the two sets of parameters. It is this Euclidean distance, in combination with the difference in RGB transformed values (106) and RGB gradient of intensity values (152) that provides a measure of the similarity between the query image 102 and the database test image 104. Specifically, the vector difference between each parameter of a query image 102 and that of database image 104 is calculated and stored as follows:

$$Dist = {( ( {\sum }_{i = 1}^{q} {( {x}_{i} - {y}_{i} )}^{2} ) \text{/} q )}^{1 \text{/} 2}$$

wherein,
q—Number of parameters (e.g. 4, pixel count, membership, cluster mean/variance)
x—Query image parameter
y—Database image parameter
   In embodiments in which multiple test images are compared to the query image, the images are sorted with respect to the query image at 125 to order the images from most similar to least similar. After sorting, the process completes at 130.

In an embodiment, the first three nearest retrieved images should be visually similar to the query image to term the query successful. In another embodiment, the query is considered satisfactory if a majority of the first eight retrieved images are visually similar in some way (either in term of the object content or color content with specific significance attached to the spatial similarity). Further, in yet another embodiment, the query is termed acceptable if a majority of the first fifteen retrieved images are in someway similar to the query image. If the query image is already present in the database, then that same image should be returned as the image most similar to the query image.

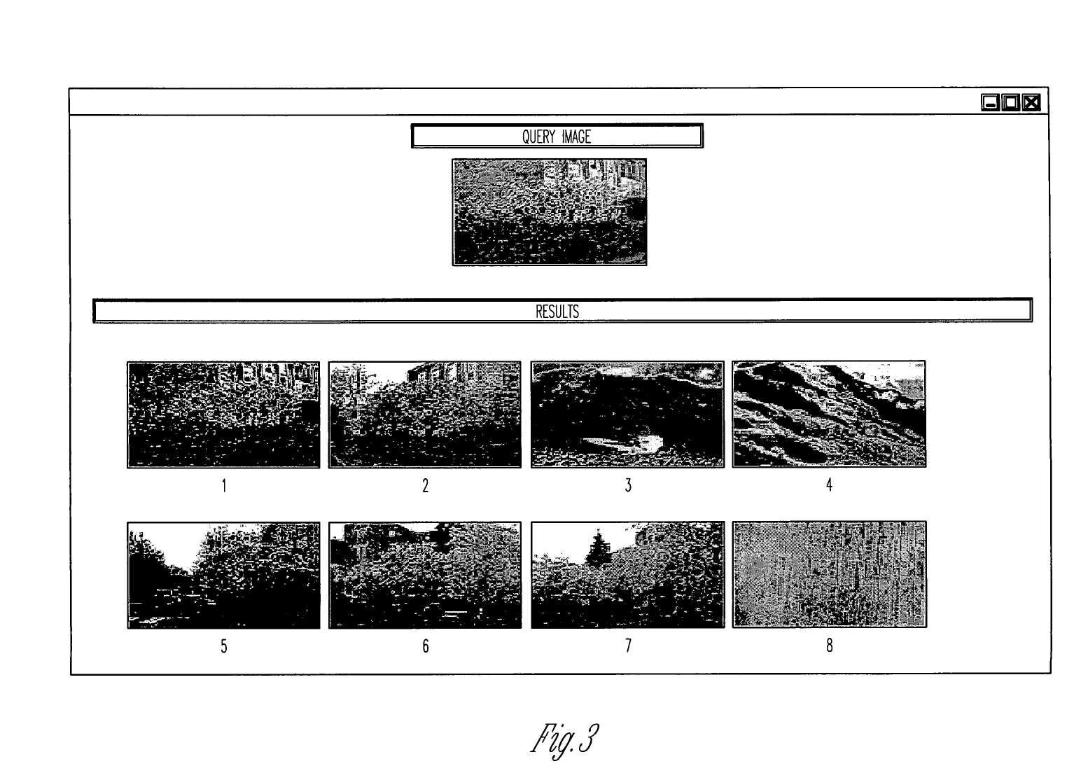

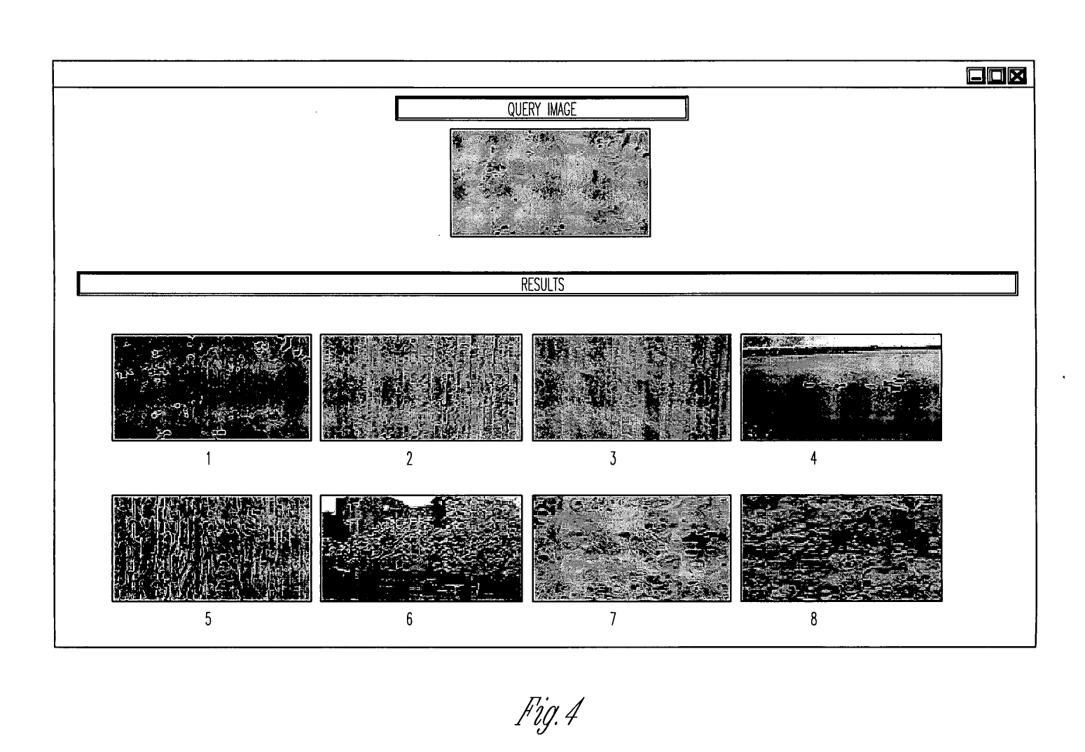

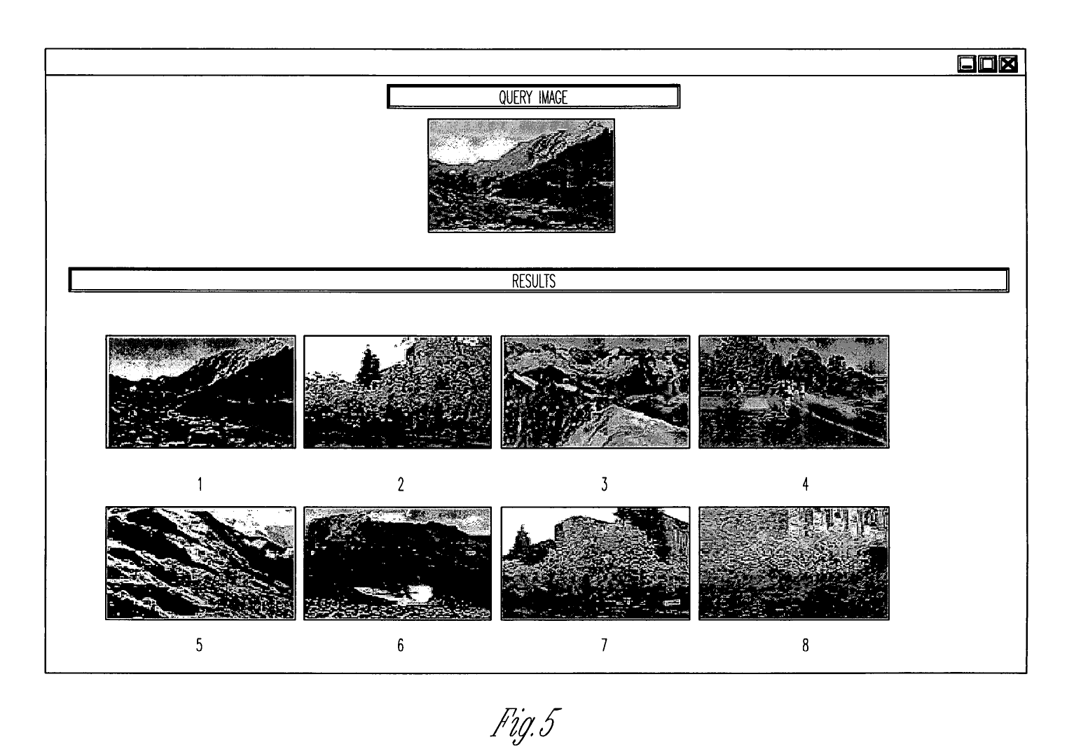

FIGS. 3, 4, and 5 illustrate sample results from different query images 102 being tested against a plurality of database test images 104. FIGS. 3, 4, and 5 show the similarity between the query image 102 and the first few database test images 104. After the few database test images, it can be seen from FIGS. 3, 4 and 5 that the similarity between the query image 102 and the test images 104 decreases.

In the foregoing detailed description of embodiments of the invention, various features are grouped together in one or more embodiments for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description of embodiments of the invention, with each claim standing on its own as a separate embodiment. It is understood that the above description is intended to be illustrative, and not restrictive. It is intended to cover all alternatives, modifications and equivalents as may be included within the scope of the invention as defined in the appended claims. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The abstract is provided to comply with 37 C.F.R. 1.72(b) to allow a reader to quickly ascertain the nature and gist of the technical disclosure. The Abstract is submitted with the understanding that it will not be used to interpret or limit the scope or meaning of the claims.

1. A method comprising:
calculating RGB values for a first image and a second image;
calculating a set of parameters for said first image and said second image;
determining a difference between said RGB values of said first image and said RGB values of said second image;
determining a difference between said parameters of said first image and said parameters of said second image; and
determining a degree of similarity between said first image and said second image as a function of said differences.

2. The method of claim 1, wherein said determining a difference between said RGB values of said first image and said RGB values of said second image further comprises:
converting R values of said first image into a first matrix of transformed values by subtracting G values of said first image from said R values of said first image;
converting G values of said first image into a second matrix of transformed values by subtracting B values of said first image from said G values of said first image;
converting B values of said first image into a third matrix of transformed values by subtracting said R values of said first image from said B values of said first image;
converting R values of said second image into a fourth matrix of transformed values by subtracting G values of said second image from said R values of said second image;
converting G values of said second image into a fifth matrix of transformed values by subtracting B values of said second image from said G values of said second image; and
converting B values of said second image into a sixth matrix of transformed values by subtracting said R values of said second image from said B values of said second image.

3. The method of claim 2, further comprising:
calculating a difference between values of said first matrix and said fourth matrix;
calculating a difference between values of said second matrix and said fifth matrix;
calculating a difference between values of said third matrix and said sixth matrix; and
determining a similarity between said first image and said second image based on said differences between said matrices.

4. The method of claim 3, further comprising:
scaling said first matrix to a range of 0 through 255;
scaling said second matrix to a range of 0 through 255;
scaling said third matrix to a range of 0 through 255; and
inputting said first scaled matrix, said second scaled matrix, and said third scaled
matrix into a K-means clustering algorithm for calculating said set of parameters for said first scaled matrix, said second scaled matrix, and said third scaled matrix, said set of parameters comprising a cluster center value, a pixel count per cluster, a cluster mean, and a cluster variance; and further comprising:
scaling said fourth matrix to a range of 0 through 255;
scaling said fifth matrix to a range of 0 through 255;
scaling said sixth matrix to a range of 0 through 255; and
inputting said fourth scaled matrix, said fifth scaled matrix, and said sixth scaled
matrix into said K-means clustering algorithm for calculating said set of parameters for said fourth scaled matrix, said fifth scaled matrix, and said sixth scaled matrix, said set of parameters comprising a cluster center value, a pixel count per cluster, a cluster mean, and a cluster variance.

5. The method of claim 4, further comprising:
determining a difference between said first matrix and said fourth matrix;
determining a difference between said second matrix and said fifth matrix; and
determining a difference between said third matrix and said sixth matrix;
wherein said differences between said matrices are determined by the following equation:
$$Dist = {( ( {\sum }_{i = 1}^{q} {( {x}_{i} - {y}_{i} )}^{2} ) \text{/} q )}^{1 \text{/} 2}$$
wherein,
q is the number of parameters in said set of parameters for said first scaled matrix, said second scaled matrix, and said third scaled matrix;
x is a parameter selected from the group consisting of said cluster center value, said pixel count per cluster, said cluster mean, and said cluster variance calculated from said first scaled matrix, said second scaled matrix, and said third scaled matrix; and
y is a parameter selected from the group consisting of said cluster center value, said pixel count per cluster, said cluster mean, and said cluster variance calculated from said fourth scaled matrix, said fifth scaled matrix, and said sixth scaled matrix.

6. The method of claim 1, wherein said determining a difference between said RGB values of said first image and said RGB values of said second image further comprises:
summing said RGB values of said first image;
summing said RGB values of said second image;
determining a difference between said summed RGB values of said first image and said summed RGB values of said second image; and
determining the similarity between said first image and said second image based on said difference between said summed RGB values of said first image and said RGB values of said second image.

7. The method of claim 1, wherein calculating said set of parameters for said first image and said second image further comprises:
calculating a cluster center value, a pixel count per cluster, a gradient magnitude mean, a gradient magnitude variance, a gradient angle mean, a gradient angle variance, and a directionality measure for said first image; and
calculating a cluster center value, a pixel count per cluster, a gradient magnitude mean, a gradient magnitude variance, a gradient angle mean, a gradient angle variance, and a directionality measure for said second image.

8. The method of claim 7, wherein calculating said gradient magnitude comprises the formula:
gradient magnitude=((A²+B²)/2)^{1/2};
wherein A is equal to the distance from a first pixel to a second pixel in a first direction; and
wherein B is equal to the distance from said first pixel to a third pixel in a second direction.

9. The method of claim 7, wherein calculating said gradient angle comprises the formula:
gradient angle=arctangent (B/A).

10. The method of claim 9, further comprising:
determining a difference between said first image and said second image by calculating a Euclidean distance between said parameters using the following formula:
$$Dist = {( ( {\sum }_{i = 1}^{q} {( {x}_{i} - {y}_{i} )}^{2} ) \text{/} q )}^{1 \text{/} 2}$$
wherein,
q is the number of said parameters in said set of parameters;
x is a parameter selected from the group consisting of said cluster center value, said pixel count per cluster, said gradient magnitude mean, said gradient magnitude variance, said gradient angle mean, said gradient angle variance, and said directionality measure for said first image; and
y is a parameter selected from the group consisting of said cluster center value, said pixel count per cluster, said gradient magnitude mean, said gradient magnitude variance, said gradient angle mean, said gradient angle variance, and said directionality measure for said second first image.

11. A computer readable medium comprising instructions thereon for executing a method comprising:
calculating RGB values for a first image and a second image;
calculating a set of parameters for said first image and said second image;
determining a difference between said RGB values of said first image and said RGB values of said second image;
determining a difference between said parameters of said first image and said parameters of said second image; and
determining a degree of similarity between said first image and said second image as a function of said differences.

12. The computer readable medium of claim 11, wherein said determining a difference between said RGB values of said first image and said RGB values of said second image further comprises:
converting R values of said first image into a first matrix of transformed values by subtracting G values of said first image from said R values of said first image;
converting G values of said first image into a second matrix of transformed values by subtracting B values of said first image from said G values of said first image;
converting B values of'said first image into a third matrix of transformed values by subtracting said R values of said first image from said B values of said first image;
converting R values of said second image into a fourth matrix of transformed values by subtracting G values of said second image from said R values of said second image;
converting G values of said second image into a fifth matrix of transformed values by subtracting B values of said second image from said G values of said second image; and
converting B values of said second image into a sixth matrix of transformed values by subtracting said R values of said second image from said B values of said second image; and further comprising:
calculating a difference between values of said first matrix and said fourth matrix;
calculating a difference between values of said second matrix and said fifth matrix;
calculating a difference between values of said third matrix and said sixth matrix; and
determining a similarity between said first image and said second image based on said differences between said matrices.

13. The computer readable medium of claim 11, further comprising:
scaling said first matrix to a range of 0 through 255;
scaling said second matrix to a range of 0 through 255;
scaling said third matrix to a range of 0 through 255; and
inputting said first scaled matrix, said second scaled matrix, and said third scaled
matrix into a K-means clustering algorithm for calculating said set of parameters for said first scaled matrix, said second scaled matrix, and said third scaled matrix, said set of parameters comprising a cluster center value, a pixel count per cluster, a cluster mean, and a cluster variance; and further comprising:
scaling said fourth matrix to a range of 0 through 255;
scaling said fifth matrix to a range of 0 through 255;
scaling said sixth matrix to a range of 0 through 255; and
inputting said fourth scaled matrix, said fifth scaled matrix, and said sixth scaled
matrix into said K-means clustering algorithm for calculating said set of parameters for said fourth scaled matrix, said fifth scaled matrix, and said sixth scaled matrix, said set of parameters comprising a cluster center value, a pixel count per cluster, a cluster mean, and a cluster variance; and further comprising:
determining a difference between said first matrix and said fourth matrix;
determining a difference between said second matrix and said fifth matrix; and
determining a difference between said third matrix and said sixth matrix;
wherein said differences between said matrices are determined by the following equation:
$$Dist = {( ( {\sum }_{i = 1}^{q} {( {x}_{i} - {y}_{i} )}^{2} ) \text{/} q )}^{1 \text{/} 2}$$
wherein,
q is the number of parameters in said set of parameters for said first scaled matrix, said second scaled matrix, and said third scaled matrix;
x is a parameter selected from the group consisting of said cluster center value, said pixel count per cluster, said cluster mean, and said cluster variance calculated from said first scaled matrix, said second scaled matrix, and said third scaled matrix; and
y is a parameter selected from the group consisting of said cluster center value, said pixel count per cluster, said cluster mean, and said cluster variance calculated from said fourth scaled matrix, said fifth scaled matrix, and said sixth scaled matrix.

14. The computer readable medium of claim 11, wherein said determining a difference between said RGB values of said first image and said RGB values of said second image further comprises:
summing said RGB values of said first image;
summing said RGB values of said second image;
determining a difference between said summed RGB values of said first image and said summed RGB values of said second image; and
determining the similarity between said first image and said second image based on said difference between said summed RGB values of said first image and said RGB values of said second image; and wherein
calculating a set of parameters for said first image and said second image further comprises:
calculating a cluster center value, a pixel count per cluster, a gradient magnitude mean, a gradient magnitude variance, a gradient angle mean, a gradient angle variance, and a directionality measure for said first image; and
calculating a cluster center value, a pixel count per cluster, a gradient magnitude mean, a gradient magnitude variance, a gradient angle mean, a gradient angle variance, and a directionality measure for said second image.

15. The computer readable medium of claim 14, wherein calculating said gradient magnitude comprises the formula:
gradient magnitude=((A²+B²)/2)^{1/2};
wherein A is equal to the distance from a first pixel to a second pixel in a first direction; and
wherein B is equal to the distance from said first pixel to a third pixel in a second direction; and wherein calculating said gradient angle comprises the formula:
gradient angle=arctangent (B/A).

16. The computer readable medium of claim 15, further comprising:
determining a difference between said first image and said second image by calculating a Euclidean distance between said parameters using the following formula:
$$Dist = {( ( {\sum }_{i = 1}^{q} {( {x}_{i} - {y}_{i} )}^{2} ) \text{/} q )}^{1 \text{/} 2}$$
wherein,
q is the number of said parameters in said set of parameters;
x is a parameter selected from the group consisting of said cluster center value, said pixel count per cluster, said gradient magnitude mean, said gradient magnitude variance, said gradient angle mean, said gradient angle variance, and said directionality measure for said first image; and
y is a parameter selected from the group consisting of said cluster center value, said pixel count per cluster, said gradient magnitude mean, said gradient magnitude variance, said gradient angle mean, said gradient angle variance, and said directionality measure for said second first image.

17. A method comprising:
calculating RGB values for a first image and a second image;
calculating a set of parameters for said first image and said second image;
determining a difference between said RGB values of said first image and said RGB values of said second image;
determining a difference between said parameters of said first image and said parameters of said second image; and
determining a degree of similarity between said first image and said second image as a function of said differences.

18. The method of claim 17,
wherein said determining a difference between said RGB values of said first image and said RGB values of said second image further comprises:
converting said RGB values of said first image;
converting said RGB values of said second image;
calculating a difference between said converted RGB values of said first image and said converted RGB values of said second image; and
determining a similarity between said first image and said second image based on said differences between said converted RGB values of said first image and said second image;
and further comprising:
scaling said differences between said converted RGB values of said first image and said converted RGB values of said second image to a range of 0 through 255;
inputting said scaled RGB values of said first image and said second image into a K-means clustering algorithm for calculating said set of parameters for said first image and said second image, said set of parameters comprising a cluster center value, a pixel count per cluster, a cluster mean, and a cluster variance;
determining a difference between said first image and said second image by the following equation:
$$Dist = {( ( {\sum }_{i = 1}^{q} {( {x}_{i} - {y}_{i} )}^{2} ) \text{/} q )}^{1 \text{/} 2}$$
wherein,
q is the number of said parameters for said first image;
x is a parameter selected from the group consisting of said cluster center value, said pixel count per cluster, said cluster mean, and said cluster variance calculated from said first scaled matrix, said second scaled matrix, and said third scaled matrix; and
y is a parameter selected from the group consisting of said cluster center value, said pixel count per cluster, said cluster mean, and said cluster variance calculated from said fourth scaled matrix, said fifth scaled matrix, and said sixth scaled matrix.

19. The method of claim 17, wherein said determining a difference between said RGB values of said first image and said RGB values of said second image further comprises:
summing said RGB values of said first image;
summing said RGB values of said second image;
determining a difference between said summed RGB values of said first image and said summed RGB values of said second image; and
determining the similarity between said first image and said second image based on said difference between said summed RGB values of said first image and said RGB values of said second image; and
wherein calculating a set of parameters for said first image and said second image further comprises:
calculating a cluster center value, a pixel count per cluster, a gradient magnitude mean, a gradient magnitude variance, a gradient angle mean, a gradient angle variance, and a directionality measure for said first image; and
calculating a cluster center value, a pixel count per cluster, a gradient magnitude mean, a gradient magnitude variance, a gradient angle mean, a gradient angle variance, and a directionality measure for said second image; and
wherein calculating said gradient magnitude comprises the formula:
gradient magnitude=((A²+B²)/2)^{1/2};
wherein A is equal to the distance from a first pixel to a second pixel in a first direction; and
wherein B is equal to the distance from said first pixel to a third pixel in a second direction; and
wherein calculating said gradient angle comprises the formula:
gradient angle=arctangent (B/A); and
further comprising:
determining a difference between said first image and said second image by calculating a Euclidean distance between said parameters using the following formula:
$$Dist = {( ( {\sum }_{i = 1}^{q} {( {x}_{i} - {y}_{i} )}^{2} ) \text{/} q )}^{1 \text{/} 2}$$
wherein,
q is the number of said parameters in said set of parameters;
x is a parameter selected from the group consisting of said cluster center value, said pixel count per cluster, said gradient magnitude mean, said gradient magnitude variance, said gradient angle mean, said gradient angle variance, and said directionality measure for said first image; and
y is a parameter selected from the group consisting of said cluster center value, said pixel count per cluster, said gradient magnitude mean, said gradient magnitude variance, said gradient angle mean, said gradient angle variance, and said directionality measure for said second first image.
